(19) United States
(12) Patent Application Publication
(10) Pub. No.: US 2005/0058581 A1
(43) Pub. Date: Mar. 17, 2005

(54) FeCrAl alloy foil for catalytic converters at medium high temperature and a method of making the material

(75) Inventors: Lichun Leigh Chen, Walpole, MA (US); Bijendra Jha, Attleboro, MA (US)

Correspondence Address: PEARNE & GORDON LLP, 1801 EAST 9TH STREET, SUITE 1200, CLEVELAND, OH, 44114-3108, US

(73) Assignee: Engineered Materials Solutions, Inc., Attleboro, MA (US)

(21) Appl. No.: 10/914,457

(22) Filed: Aug. 9, 2004

Related U.S. Application Data
(60) Provisional application No. 60/493,168, filed on Aug. 7, 2003.

(51) Int. Cl. B23K 20/04; B01D 53/34

(52) U.S. Cl. 422/180; 422/177; 29/890; 428/606; 228/235.2; 228/262.44; 148/531; 148/535

(57) ABSTRACT

A FeCrAl alloy for catalytic converter substrates having excellent oxidation resistance and dimension stability at a medium high temperature, e.g. the temperature encountered by catalytic converter substrates in truck diesel engines, without necessary addition of extra Y, Hf, or rare earth elements beyond that inherently present in commercial stainless steel. A roll bonding and diffusion alloying annealing method is used for making such materials with the following two deviated paths. First, material in which layers of ferritic stainless steel and aluminum are solid state metallurgically bonded together forming a multilayer composite material. Such composite material is then further rolled to an intermediate foil gauge and then subjected to a thermal reaction to form a resulting uniform solid solution foil material followed by rolling to the final foil thickness. Alternatively, such composite material is further rolled to the final foil thickness and then subjected to a thermal in-situ reaction in the material after a honeycomb-like catalytic converter is made from the foil composite material. Both deviated approaches result in a uniform solid solution foil material.

This application relates generally to a method of producing an alloyed foil substrate material for use in diesel engine exhaust systems and other exhaust systems that operate at temperatures of up to at least 800° C. More specifically, this application relates to a method of producing an iron-chromium-aluminum (FeCrAl) alloy foil for use in catalytic converters without the need for addition of extra yttrium (Y), hafnium (Hf), or rare earth elements so that the semi-cyclic oxidation resistance and dimension stability of the foil is improved at a temperature of about 800° C.

### BACKGROUND OF THE INVENTION

This invention provides an alloy material having corrosion resistance at medium-high temperatures and a method of manufacture thereof. More particularly, the invention relates to a metal foil alloy material and a method for producing the metal foil alloy material for use in catalytic converters, especially for catalytic converters which are used in truck diesel engines and other diesel engine applications which tend to operate at lower temperatures compared to conventional gasoline combustion engines.

As is well known, exhaust gases discharged from motor vehicles may contain halogen gases, halogen compounds and lead compounds, for example, Cl₂, Br₂, PbCl₂, C₂H₂Cl₂, C₂H₂Br₂, etc., besides unburned noxious gases including carbon monoxide, hydrocarbon and the like. Various components or parts of the exhaust systems of motor vehicles which are made of ferrous base alloy materials, for example, heat exchangers, air ducts, containers, etc., tend to be subjected to corrosion by exposure to the noxious compounds described above. Moreover, halogen compounds, such as road salt typically employed for preventing freezing of road surfaces during cold seasons, are liable to enter these components of ferrous base alloy material, causing corrosion upon exposure to halogen gas produced when the halogen compounds are decomposed at high temperatures which are typically present in automotive exhaust systems.

At one point in time, ceramic material substrates were utilized in forming the components in automobiles which were subject to the high temperatures and corrosive gasses in exhaust systems. Further, it has been known to use metal foil materials as substrates with an appropriate catalyst coating in place of ceramic material substrates. Such metal foil material has been made in the past by ingot metallurgy from steel sheets containing aluminum (Al) and also chromium (Cr), thereby forming FeCrAl alloys, in order to have the desired corrosion resistance at high temperatures which exist in catalytic converters. These FeCrAl alloys, however, are difficult to produce by conventional rolling and annealing processes. To overcome the processing difficulties, it has been suggested, as in EP application 91115501.8, to produce the foil by a rapid solidification processing method. However, such processing is expensive and requires very precise controls. It has also been suggested to dip the stainless steel in a molten bath of aluminum or aluminum alloy to apply melt-plating on the surface of the stainless steel (U.S. Pat. Nos. 3,907,611, 3,394,659 and 4,079,157). This stainless steel with the aluminum is then subjected to a heat treatment to form an alloy layer having Fe and Al as the main components. Still further, surface layers of aluminum in binder materials, as described in U.S. Pat. No. 4,228,203, have also been suggested. However, in all of these applications the control of the processing parameters is complex and expensive. Further, the final foil has not proven, in many cases, to have the desired corrosion/oxidation resistance at elevated temperatures as required in the catalytic converter industry.

Still two other approaches are to manufacture the catalytic converter substrate material by using a metallurgically bonded composite material with layers of ferritic stainless steel and aluminum as described in U.S. Pat. No. 5,366,139 and Pat. No. 5,980,658 owned by the assignee of this instant application.

The FeCrAl alloy foil has been used as a substrate for catalytic converters for emission control. The normal requirements of the alloy foils for automobile gasoline engine applications are good oxidation resistance and dimension stability at 1100° C. In order to meet the requirements, alloy chemistry normally must contain 18˜22 wt % chromium and 4.5˜6 wt % aluminum and certain small amount(s) of Y, Hf and/or rare earth elements beyond that which is normally present in stainless steel. This will make the alloy foil more expensive because Y, Hf, and rare earth metal are quite expensive and because of the nature of the resulting alloying and the alloy processes. The cost becomes a more concerning issue as the applications of catalytic converters have been extended to truck diesel engines, where maximum service temperature is usually only up to 600° C. or so. At such operating temperatures, an FeCrAl substrate foil lacking the addition of extra Y, Hf, and/or rare earth elements beyond the amounts normally present in stainless steel has now been found to have acceptable oxidation resistance and dimensional stability.

### SUMMARY OF THE INVENTION

Accordingly, the present invention provides for an innovative foil alloy containing Cr between about 9 wt % to about 18 wt %, Al between about 4 wt % to about 9 wt %, without addition of extra Y, Hf, or other rare earth elements. The invention also relates to a method of manufacturing the above described foil alloys wherein the resulting foil alloys have excellent oxidation resistance and dimension stability within a temperature range commonly present in catalytic converters utilized in truck diesel engines, and other diesel engines, up to about at least 800° C. The foil material is thus more easily and more economically manufactured for high volume applications due to the elimination of the need for the extra Y, Hf and/or rare earth elements.

The new alloys of the invention contain Cr between about 9 wt % to about 18 wt % and Al between about 4 wt % to about 9 wt %. The alloys of the invention were made by first bonding common commercial ferritic iron-chromium (FeCr) stainless steel, such as 405SS, 430SS, 439SS and 409SS, with commercial pure aluminum and then diffusion alloying. In brief, a multilayer composite comprising sandwiched Al/FeCr stainless steel/Al was first made by roll-bonding FeCr stainless steel between layers of Al. The multilayer Al/FeCr/Al composite was then further rolled down either to an intermediate thickness or to a final foil thickness.

In one aspect of the invention, the multilayer composite is rolled to an intermediate thickness as mentioned previously. The intermediate thickness is a thickness which is between a thickness after bonding and a final thickness. The intermediate thickness multilayer composite is then diffusion heat treated at a temperature of between about 900° C. to about 1200° C. for a period of time that is sufficient for diffusion alloying to obtain a monolithic, uniform, solid solution alloy material. The monolithic, uniform, solid solution alloy material is then finish rolled to a final foil thickness. The final foil can then be used for catalytic converter fabrication, including forming the material into a honeycomb-like structure.

In another aspect of the invention, the roll-bonded multilayer Al/FeCr/Al composite is formed in the same manner as described above but is rolled to a final foil thickness rather than an intermediate thickness. A catalytic converter, including one with a honeycomb-like structure, can then be made directly from final thickness multilayer composite foil through certain processes, including slitting, cleaning, foil corrugation, corrugated and flat foils winding or stacking. The catalytic converter body is then heat treated at a temperature between about 900° C. and about 1200° C. for a period of time that is sufficient to cause diffusion of the various constituents in the layers of the composite material throughout the foil.

In both cases as described above (initial rolling to either an intermediate or final foil thickness), the composite forms a final material, after heating, having the complete presence of the constituents of the aluminum layer and the stainless steel layers intimately dispersed throughout the whole foil material. The semi-cyclic oxidation resistance and dimension stability attained from such a material are excellent at temperature of up to at least 800° C.

In a further aspect of the invention, the layers may comprise Al sandwiched between FeCr stainless steel layers. This material can then be processed according to either method (intermediate or final finish rolling) as described above.

The materials made from this invention may easily be made from starting materials that are commercially available, such as common grade stainless steel and aluminum. It is not necessary for alloys to contain additional, expensive Y, Hf, rare earth elements, normally utilized in alloys for conventional gasoline engine materials, to obtain the excellent cyclic oxidation resistance and dimension stability at a temperature of up to at least 800° C. which is typical for diesel engine applications.

These and other aspects of the invention can be realized from a reading and understanding of the detailed description and drawings.

### BRIEF DESCRIPTION OF THE DRAWINGS

FIG. 1 shows a side elevation view diagrammatically illustrating the bonding method of this invention;

FIG. 2 shows the composite material of this invention after bonding;

FIG. 3 diagrammatically shows the material of this invention after diffusion heat treatment.

FIG. 4 shows the material used in a catalytic converter.

FIG. 5 shows a photomicrograph of the material of FIG. 3.

FIG. 6 Material oxidation weight gain in the samples by the first deviated manufacturing approach path at 800° C. temperature in air.

FIG. 7 Length change of the samples by the first deviated manufacturing approach path.

FIG. 8 Material oxidation weight gain in the samples by the second deviated manufacturing approach path at 800° C. temperature in air.

FIG. 9 Length change of the samples by the second deviated manufacturing approach path.

### DETAILED DESCRIPTION OF THE PREFERRED EMBODIMENTS

Some aspects of this invention have been disclosed in provisional application Ser. No. 60/457,079, now U.S. application No. 10/807,792, incorporated herein by reference.

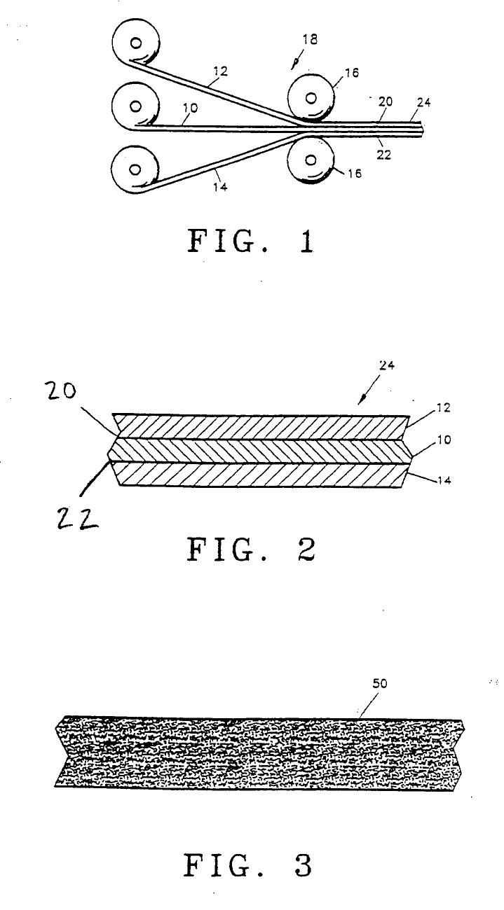

In accordance with the invention, a first central layer 10 of ferrous material, such as stainless steel, is sandwiched between two outer layers 12 and 14 of aluminum or aluminum alloy material. The three layers are passed between a pair of pressure rolls 16 in a conventional rolling mill 18 as shown in FIG. 1. The layers are squeezed together with sufficient force to be reduced in thickness, and metallurgically bonded together along interfaces 20 and 22 between the metal layers wherein a composite multilayer metal material 24 is formed as shown in FIG. 2. The material is then continuously rolled to a desired foil thickness (which can be either an intermediate or final thickness) and thermally reacted into a foil sheet 50 shown in FIG. 3, as will be explained in greater detail below.

Typically, the first central layer 10 comprises a common commercial ferritic stainless steel with between about 10.5 wt % to about 18.0 wt % Cr, and the balance Fe with other unavoidable residual elements. Examples of such ferritic stainless steels are 405, 409, 430 and 439 stainless steels. Preferably, top and bottom layers 12 and 14 are of the same thickness and material, and are comprised of essentially pure aluminum, although aluminum alloys could also be used.

It is to be understood that the invention could equally well be practiced with a central relatively thinner layer of aluminum or aluminum alloys, and top and bottom layer of the ferritic stainless steel material. The invention will be described below using the Al/FeCr stainless steel/Al configuration as the example.

In a preferred embodiment having excellent medium-high temperature oxygen corrosion resistance, it has been found desirable to have a final chemistry in the final material 50 after thermal reaction (to be explained in detail below) of between about 9 wt % to about 18 wt % Cr, at least about 4 wt % and up to 9 wt % Al and the balance Fe. Additionally, small amounts of zirconium (Zr), niobium (Nb) or titanium (Ti) can be added to either of the metals forming the composite to form nitride or carbide with carbon and nitrogen to reduce the amount of such free interstitial elements in a solid solution. It should be pointed out that the need to include small amounts of Y, Hf or a rare earth metal element such as lanthanum (La), cerium (Ce), praseodymium (Pr), neodymium (Nd), etc., beyond that which is normally inherently present in stainless steel, is eliminated when forming the composite of the present invention. The presence of excess Y, Hf or a rare earth metal element has been found to not be required in the alloys of the invention for the medium-high temperature oxidation resistance and dimension stability required for diesel applications, unlike the typical automotive application.

An example of such an embodiment is where a layer of 430 stainless steel, having a thickness typically of between 0.050 and 0.075 of an inch, is roll bonded to essentially pure aluminum top and bottom layers having a thickness typically of between 0.004 and 0.009 of an inch thereby yielding a bonded composite of approximately 0.015 to 0.040 of an inch as shown in FIG. 3. The initial starting thicknesses of the layers have been chosen to determine the ultimate chemistry of the final composite after thermal reaction.

There are two deviated approach paths to form the final product after roll bonding as described above:

In the first case, the composite 24 as shown in FIG. 2 is cold rolled by conventional means from the bonding thickness to a pre-selected intermediate thickness. The intermediate thickness lies between the bonding thickness and final foil thickness. The intermediate thickness is chosen per U.S. Pat. No. 5,980,658, incorporated herein by reference, so that the percentage reduction from the intermediate thickness to final foil thickness will be about 50% to about 75%. At this intermediate thickness, the rolled foil is then internally reacted or heat treated at a temperature between about 900° C. and about 1200° C., and preferably at about 1000° C. for between 1 minute and 60 minutes or longer as required to provide for diffusion of the various constituents in the composite throughout the foil material. That is, after this heat-treating operation, also referred to as diffusion annealing, the microstructure of the foil will not be the original three layer structure; but instead a monolithic, uniform or nearly uniform, solid solution alloy as shown in FIG. 5 will be created. It is preferable that the heat-treating be for a period of time that is sufficient to dissolve any formed intermetallic compounds. This heat treating is done preferably at a temperature which does not allow for the formation of a brittle sigma phase of CrFe or other brittle compounds. The heat treating can be done in a vacuum, reducing atmosphere or in an inert atmosphere or in air. The rolled, heat treated foil having the intermediate thickness is then finish rolled to a final foil thickness. This final foil thickness alloy foil can be used for catalytic converter fabrication, including honeycomb-like components used in catalytic converters.

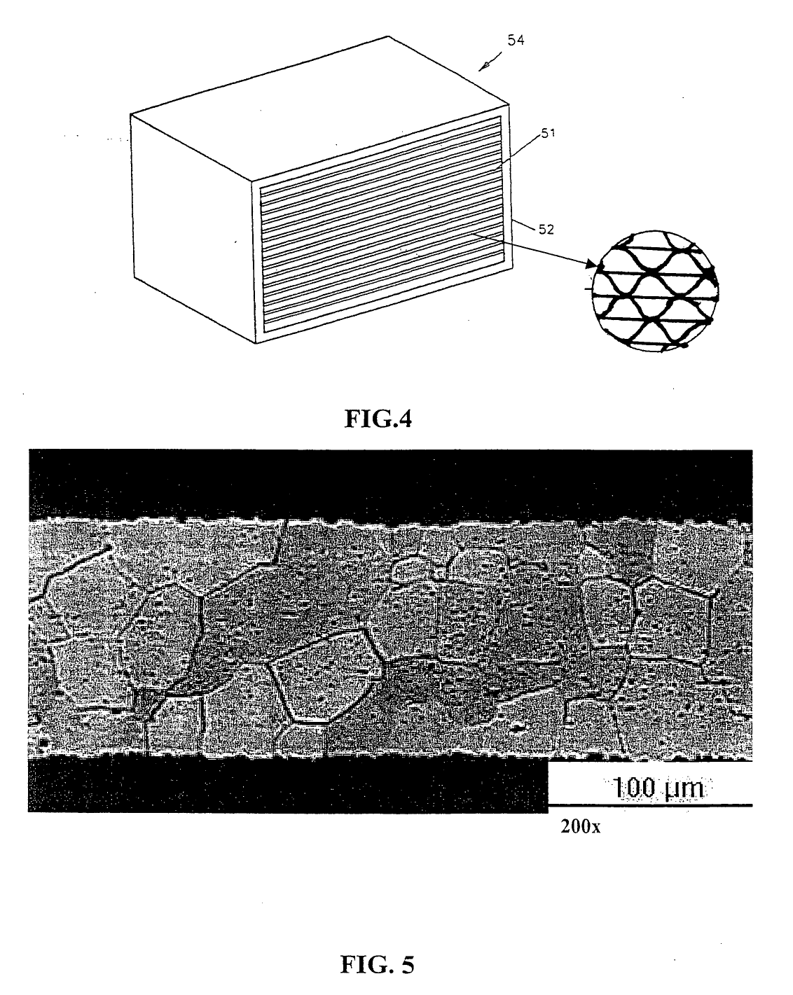

In the second case, the composite 24 is cold rolled by conventional means from the bonding gauge to the final foil thickness typically of about 0.002 inches thereby forming a finish rolled foil. This finish rolled foil is then processed to a proper width, cleaned and corrugated or formed into wavy-like structures. The corrugated composite foil and/or wavy-like structures are then wound or stacked with flat composite foil to make a honeycomb-like catalytic converter body with a certain means of restraining at its outside as shown in FIG. 4. The honeycomb-like catalytic converter body and thus the composite foil is then thermally reacted or heat treated at a temperature between about 900° C. and about 1200° C., and preferably about or above 1000° C., for between 1 minute and 60 minutes or longer to provide for diffusion of the various constituents in the composite throughout the foil material. That is, after this heat-treating operation, also referred to as diffusion annealing, the microstructure of the foil will not be the original three layer structure; but instead a monolithic, uniform or nearly uniform, solid solution alloy. It is preferable that the heat-treating be for a period of time that is sufficient to dissolve any formed intermetallic compounds. This heat treating is done preferably at a temperature which does not allow for the formation of a brittle sigma phase of CrFe or other brittle compounds. The heat treating can be done in a vacuum, reducing atmosphere or in an inert atmosphere or in air.

In order to give greater appreciation of the advantages of the invention, the following examples are given:

### EXAMPLE I

A continuous strip of annealed commercial 430 stainless steel containing 17% Cr at a thickness of 0.077 of an inch was sandwiched between two continuous strips of Al foils in a single operation to yield a solid state metallurgically bonded three layer composite as described in U.S. Pat. No. 5,366,139. This continuous strip was cold rolled on a conventional rolling mill in multiple passes until an intermediate thickness of 0.004 inches was achieved. This foil material was then cleaned and heated to 1000° C. in vacuum for 90 minutes to diffuse all the aluminum into the stainless steel base, thereby forming a uniform, solid solution alloy foil material. The foil material was then cold-rolled on a conventional rolling mill in multiple passes to a final thickness of 0.002 inches. The foil material shows a nominal chemical composition (in weight percentage) of:

Cr: 16.4%

Al: 5.2%

C: 0.05%

Ni: 0.2%

Mn: 0.5%

S: 0.001%

La: <0.001%

Ce: <0.002%

Pr: 0.003%

Y: <0.0005%

Hf: <0.002%

Zr: 0.003%

Ti: 0.004%

### EXAMPLE II

This example was carried out identical to Example I above except the starting thickness of the 430 stainless steel center strip used was at 0.060 inches. Therefore, the finished, uniform solid solution alloy foil material has 15.2% Cr and 7.2% Al, with the amounts of minor chemical composition being virtually the same as in Example I.

### EXAMPLE III

This example was carried out identical to Example I above except that the 430 stainless steel in the central strip was replaced by a commercial 409 stainless steel containing nominally about 12% Cr with minor amount of Ti, at a thickness of 0.075 inch. After the processing, the finished, uniform solid solution alloy foil material shows a chemical composition (in weight percentage) of:

Cr: 11.3%

Al: 5.8%

C: 0.05%

Ni: 0.2%

Mn: 0.4%

S: 0.001%

La: <0.001%

Ce: <0.002%

Pr: <0.005%

Y: <0.0005%

Hf: <0.002%

Zr: 0.004%

Ti: 0.32%

Nb: 0.01%

### EXAMPLE IV

This example was carried out identical to Example III above except the starting thickness of the 409 stainless steel center strip used was at 0.062 inches. Therefore, the finished, uniform solid solution alloy foil material has 11.2% Cr and 6.6% Al, with the amounts of minor chemical composition being visually the same as in EXAMPLE III.

Table 1 lists nominal chemical compositions of the materials in Examples I to IV in weight percentage.

TABLE 1
Chemical Composition of the Materials (Weight %)

| Example | Cr | Al | C | Mn | Si | Ni | La | Ce | Pr | Hf | Y | Ti | Nb | Zr | N | S |
|---|---|---|---|---|---|---|---|---|---|---|---|---|---|---|---|---|
| I | 16.4 | 5.2 | 0.05 | 0.4 | 0.4 | 0.2 | 0.0008 | 0.0016 | 0.003 | <0.002 | <0.000 | 0.004 | — | 0.003 | 0.01 | 0.001 |
| II | 15.2 | 7.1 | 0.05 | 0.4 | 0.4 | 0.2 | 0.0009 | 0.0016 | 0.003 | <0.002 | <0.000 | 0.004 | — | 0.003 | 0.01 | 0.001 |
| III | 11.3 | 5.8 | 0.03 | 0.3 | 0.5 | 0.2 | 0.0006 | 0.0018 | 0.004 | <0.002 | <0.000 | 0.32 | 0.01 | 0.004 | 0.01 | 0.001 |
| IV | 11.1 | 6.6 | 0.03 | 0.3 | 0.5 | 0.2 | 0.0006 | 0.0018 | 0.004 | <0.002 | <0.000 | 0.3 | 0.006 | 0.003 | 0.01 | 0.001 |

### EXAMPLE V

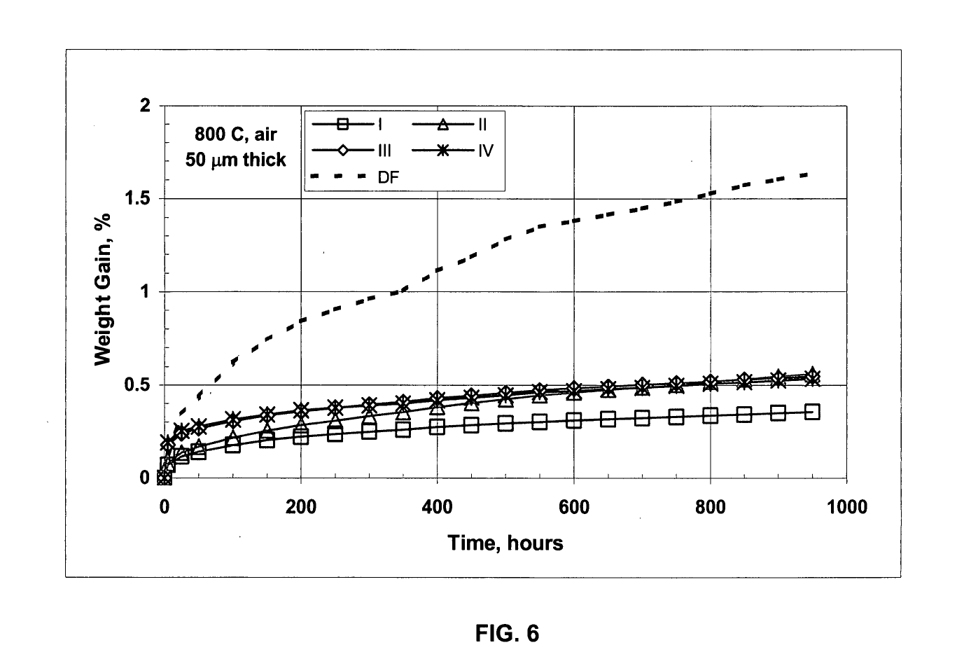

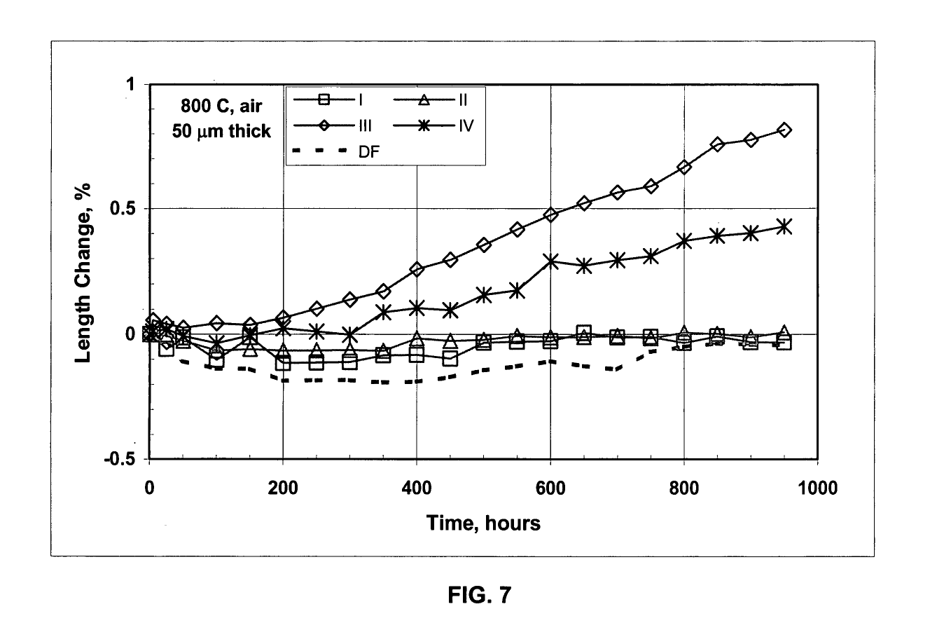

The final rolled foil material having a thinkness of 0.002 inches made in Examples I, II, III and IV was corrugated and wound with a flat foil of the same material, respectively, after processing for proper foil width and surface cleanness to make a honeycomb-like catalytic converter roll test sample. The honeycomb-like catalytic converter test samples were annealed at 1150° C. for 30 minutes in vacuum. Then, the honeycomb-like catalytic converter test samples were tested in air for oxidation resistance and dimension stability as described following. The samples were heated from a room temperature atmosphere to the testing temperature, 800° C., in 2 hours and held for a certain time and then cooled down to the room temperature in 6 hours in a conventional open-air heat treatment furnace. The holding time of a cycle was as 5 hours, 20 hours, 25 hours, 50 hours, 50 hours, . . . , 50 hours, until total accumulated time reached 950 hours. The weight gain due to oxidation and length change between two ends of the honeycomb-like roll testing sample were measured at the end of each cycle. FIGS. 6 and 7 show the test results of oxidation weight and length change, respectively.

The results as shown in FIGS. 6 and 7 demonstrate that the materials have good oxidation resistance and dimension stability at 800° C. in air, and well below an acceptable criterion in maximum weight gain and length change. One of the criteria, maximum weight gain, is 6% at the given thickness of 0.002 inches and maximum length change is 2%.

In the same figures, a reference material DF is also tested and showed. It has a nominal chemical composition (in weight percentage) of:

Cr: 21%

Al: 6.3%

C: 0.013%

Ni: 0.13%

Mn: 0.29%

S: 0.0003%

La: 0.0099%

Ce: 0.031%

This reference material has a higher chromium amount, includes the rare earth elements lanthanum and cerium, and is relatively costly to process to the foil thickness with about 6% aluminum. It is normally used as substrate material for the catalytic converters that are utilized for gasoline automotive engines that reach temperatures up to 1100° C. It should be pointed out that the innovative materials in this invention have the similar oxidation resistance and dimension stability at 800° C. as the reference material but are much less expensive to manufacture due to the absence of the rare earth elements.

### EXAMPLE VI

This example was carried out identical to Examples I to IV above except further cold rolling after roll bonding continued to the final thickness of 0.002 inches prior to the thermal treatment. At this stage, four different combinations of multilayer composite foil materials were made, corresponding to Examples I, II, III and IV, respectively. The composite foil material was then corrugated and wound with a flat composite foil material of the same type, after certain processes for proper foil width and surface cleanness, to make a honeycomb-like catalytic converter roll sample. The sample was restrained with a certain approach at its outside wrap. The honeycomb-like catalytic converter roll test samples were heated to 1150° C. and held for 30 minutes followed by cooling in vacuum. This heat-treating operation made the aluminum, along with all of the other various constituents in the composite of the honeycomb-like converter sample, diffuse uniformly throughout the foil material thereby forming a completed, uniform solid solution material for the honeycomb-like converter sample. The nominal chemical compositions of the four final completed uniform solid solution materials are visually the same as the corresponding materials in Examples I, II, III and IV, respectively.

### EXAMPLE VII

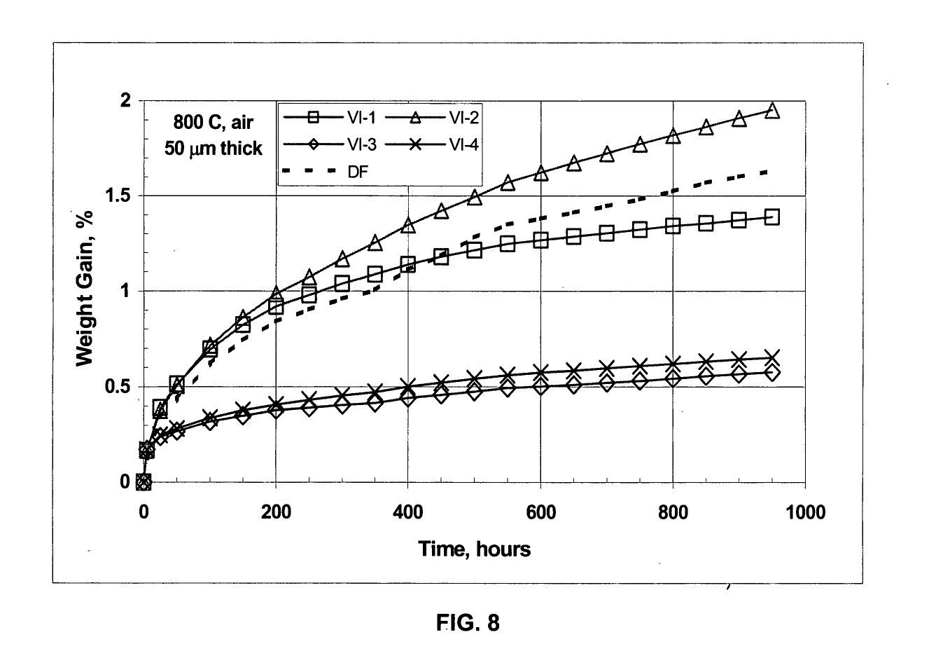

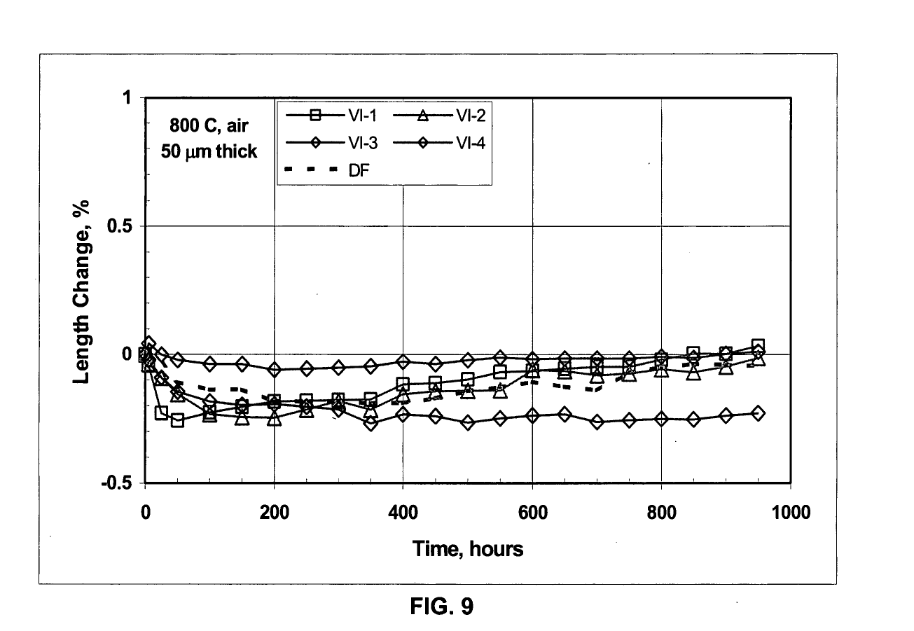

The honeycomb-like catalytic converter roll samples of Example VI were then tested in air at 800° C. for oxidation resistance and dimension stability measurement, as described in Example V. The test results, seen in FIGS. 8 and 9, showed that the materials have good oxidation resistance (low oxidation weight gain) and dimension stability (low length change). Both oxidation weight gain and length change are below acceptable criteria in maximum weight gain and length change. The criterion for maximum weight gain is 6% at the given thickness of 0.002 inches and the criterion for maximum length change is 2%. Again, the oxidation resistance and dimension stability of the materials are in a similar range to the one for reference material DF (having higher Cr % and containing rare earth elements La and Ce) at 800° C.

Table 2 summarizes the tests results of oxidation weight gain and length change percentage after total accumulated 950 hours tested at 800° C. in air.

TABLE 2
Summary of Test Results

| | Example | | | | | | | | |
|---|---|---|---|---|---|---|---|---|---|
| | I | II | III | IV | VI-1 | VI-2 | VI-3 | VI-4 | DF |
| Weight | 0.35 | 0.56 | 0.55 | 0.53 | 1.39 | 1.95 | 0.58 | 0.65 | 1.63 |
| Gain % | | | | | | | | | |
| Length | −0.03 | 0.01 | 0.82 | 0.43 | 0.03 | −0.01 | 0.01 | −0.23 | −0.04 |
| Change | | | | | | | | | |
| % | | | | | | | | | |

The novel process and article produced by method of the present invention provides for a foil material for use in catalytic converters with good corrosion resistance at elevated temperatures of about at least 800° C. wherein the need for inclusion of additional Y, Hf and/or rare earth elements, beyond that which is inherently present in commercially available stainless steels, is eliminated. The material is easily and economically manufactured having a selectively predetermined desired chemical composition. The chemical composition is uniform throughout the foil sheet.

The invention has been described hereinabove using specific examples. However, it will be understood by those skilled in the art that various alternatives may be used and equivalents may be substituted for elements or steps described herein, without deviating from the scope of the invention. Modifications may be necessary to adapt the invention to a particular situation or to particular needs without departing from the scope of the invention. It is intended that the invention not be limited to the particular implementation described herein, but that the claims be given their broadest interpretation to cover all embodiments, literal or equivalent, covered thereby.

1. A method for making a foil substrate material for catalytic converters which operate at temperatures of up to about 800° C., comprising the steps of:
a) providing a first layer of a first material selected from FeCr metals, aluminum and aluminum alloys;
b) sandwiching the first layer of the first material between a first and second layer of one or more second material(s) which is different from the first material and is selected from FeCr metals, aluminum and aluminum alloys, thereby producing a multilayer composite;
c) compaction rolling the multilayer composite to form an intermediate thickness composite foil;
d) heating the intermediate thickness composite foil at a temperature of between about 900° C. to about 1200° C. for a period of time which is sufficient to cause diffusion of said one or more second metal materials into said first metal materials to produce a uniform, solid solution alloy foil;
e) cooling the uniform, solid solution alloy foil to room temperature;
f) rolling the uniform, solid solution alloy foil to a finish thickness.

2. The method according to claim 1 wherein said first material is a FeCr stainless steel and said second material is aluminum or aluminum alloy.

3. The method according to claim 2, wherein the FeCr stainless steel is selected from stainless steel 405, 430, 439 and 409.

4. The method according to claim 1 wherein said heating step d) further comprises maintaining said multilayer composite material at peak temperature for between about 1 and about 60 minutes.

5. The method according to claim 1 wherein a chemical composition of the uniform, solid solution alloy foil of step f) is between about 9 wt % and 18 wt % Cr, at least about 4 wt % up to about 9 wt % Al, and the balance Fe.

6. The method according to claim 1 wherein said intermediate thickness is between about 0.002 inches and about 0.008 inches.

7. The method according to claim 6 wherein said finish thickness is between about 0.0010 inches and about 0.003 inches.

8. The method of claim 1 wherein a thickness reduction from said intermediate thickness and said finish thickness is between about 50% and 75%.

9. The method according to claim 1 further including annealing the uniform, solid solution finish thickness alloy foil formed in step f).

10. A method for making catalytic converters which operate at temperatures of up to about 800° C. wherein the catalytic converter contains structures comprising a foil substrate material, comprising the steps of:
a) providing a first layer of a first material selected from FeCr metals, aluminum and aluminum alloys;
b) sandwiching the first layer of the first material between a first and second layer of one or more second material(s) which is different from the first material and is selected from FeCr metals, aluminum and aluminum alloys, thereby producing a multilayer composite;
c) compaction rolling the multilayer composite to form a finish thickness composite foil;
d) forming the finish thickness composite foil into structures used in a catalytic converters, including wavy-like or corrugated structures and flat structures, and incorporating the structures into a honeycomb-like catalytic converter body thereby forming a catalytic converter with air-flow channels;
e) heating the catalytic converter containing the structures formed from the finish thickness composite foil at a temperature of between about 900° C. to about 1200° C. for a period of time which is sufficient to cause diffusion of said one or more second metal materials into said first metal materials contained in the finish thickness composite material to produce a uniform, solid solution alloy foil containing catalytic converter;
f) cooling the uniform, solid solution alloy foil containing catalytic converter to room temperature.

11. The method according to claim 10 wherein said first material is a FeCr stainless steel and said second material is aluminum or aluminum alloy.

12. The method according to claim 11 wherein the FeCr stainless steel is selected from stainless steel 405, 430, 439 and 409.

13. The method according to claim 10 wherein said heating step e) further comprises maintaining said catalytic converter at peak temperature for between about 1 and about 60 minutes.

14. The method according to claim 10 wherein a chemical composition of the uniform, solid solution alloy foil is between about 9 wt % and 18 wt % Cr, at least about 4 wt % up to about 9 wt % Al, and the balance Fe.

15. The method according to claim 10 wherein said finish thickness composite foil is between about 0.0010 inches and about 0.003 inches.

16. The method according to claim 10 further including annealing the uniform, solid solution finish thickness alloy foil containing catalytic converter formed in step f).

17. A product produced in accordance with the process of claim 1.

18. A product produced in accordance with the process of claim 2.

19. A product produced in accordance with the process of claim 10.

20. A product produced in accordance with the process of claim 11.

21. A catalytic converter comprising a product of claim 17.

22. A catalytic converter comprising a product of claim 18.
